(19) United States
(12) Patent Application Publication
(10) Pub. No.: US 2003/0061621 A1
(43) Pub. Date: Mar. 27, 2003

(54) Transportable LAN-based surveillance system

(75) Inventors: Kevin Petty, Garland, TX (US); David Banks, Dallas, TX (US); Tim Lee, Beverly Hills, CA (US)

Correspondence Address: Steven W Smith, 840 Central Parkway East, Suite 120, Plano, TX, 75074, US

(73) Assignee: Micro Technology Services, Inc.

(21) Appl. No.: 09/965,112

(22) Filed: Sep. 26, 2001

(51) Int. Cl. H04N 7/173

(52) U.S. Cl. 725/105

(57) ABSTRACT

A transportable security surveillance system for rapid installation in the office of an employee who may face a potentially violent situation. An Ethernet LAN connects a central security computer in a central security station to an audio-video compressor (AVC) in the employee's office. A covert video camera and a microphone in the employee's office provide video and audio data to the AVC. The employee is provided with a triggering device that triggers the AVC to begin streaming real-time audio and video data over the LAN to the central security computer when a situation arises that requires real-time surveillance of the employee's office. Before the trigger, no data is transmitted over the LAN. Pre-trigger data may be stored in an AVC memory, and may be retrieved for later analysis following a triggering event.

### BACKGROUND OF THE INVENTION

1. Technical Field of the Invention

This invention generally relates to security surveillance systems. More particularly, and not by way of any limitation, the present invention is directed to a security surveillance system that connects transportable surveillance equipment to a central security station utilizing a Local Area Network (LAN).

2. Description of Related Art

There is a growing threat to employees from workplace violence. An employee may have a problem with, for example, an estranged spouse or ex-spouse, who may show up at their office and cause trouble. Alternatively, a disgruntled employee or ex-employee may decide to take out his or her frustrations on their fellow employees. These are typically situations that arise with little or no notice. The situations are typically of short duration, but may become lengthy if a perpetrator decides to isolate himself and one or more employees who become hostages.

Corporations concerned with risk management need to pay special attention to the rising problem of workplace violence. If an employee reports a potentially violent situation to company management prior to its occurrence, and management does not do anything about it, the company may be held at least partially liable for any injuries that their employee incurs as a result. This is especially true for large corporations that have security personnel on site, but those personnel were not properly assigned to handle the potentially violent situation.

From the company's point of view, it is not practical to assign a security guard to continuously watch the office of an employee who has reported that a violent situation may arise. First, the situation may never arise. Second, the guard may be needed to perform other routine patrols. Third, the guard may need to take breaks, and the perpetrator could slip in during those times. Finally, in a large corporation, there could be multiple employees that report potentially violent situations, and the company cannot assign a guard to each one of them.

One solution to this problem is to install a video surveillance system to monitor the employee's office. Video surveillance systems currently exist, and are widely used by security departments in large corporations to monitor restricted areas, or to monitor the company premises after hours. One such system is described in U.S. Pat. No. 6,069,655 to Seeley et al. which is assigned to Wells Fargo Alarm Service, Inc. The Wells Fargo system includes a plurality of video surveillance cameras installed on a customer premises. An Integrated Services Digital Network (ISDN) is used to transmit video and audio information back to a central station where the information is presented to security personnel.

However, existing video surveillance systems such as the Wells Fargo system have several shortcomings that make them ill-suited for countering the problem of workplace violence. First, such systems require extensive infrastructure development, including the installation of cable and the mounting of video cameras. It is cost-prohibitive to perform this development for every employee who reports a potentially violent situation, especially since the situation may be short-lived, and the need for the installation may end in a short period of time. Additionally, such extensive installation prevents such systems from being rapidly deployed in response to a potential workplace violence situation. Second, the installation of such a system creates an additional problem relating to employee privacy. It is objectionable to most employees to have their workplace continuously monitored by management. However prior art video surveillance systems continuously monitor the areas where they are installed, and are thus unsuitable for monitoring workplaces.

In order to overcome the disadvantage of existing solutions, it would be advantageous to have a security surveillance system that connects transportable surveillance equipment to a central security station utilizing an existing LAN. The present invention provides such a system.

### SUMMARY OF THE INVENTION

In one aspect, the present invention is a transportable security surveillance system for rapid installation in an area of interest and rapid extraction from the area of interest. The system includes a local area network (LAN) connecting a central security station to the area of interest; a central security computer in the central security station connected to the LAN; and an audio-video compressor (AVC) in the area of interest connected to the LAN. A video camera is connected to the AVC for providing video data regarding the area of interest. A microphone is connected to the AVC for providing audio data regarding the area of interest. A triggering device such as a wireless remote control creates a trigger indication when a situation arises that requires real-time surveillance of the area of interest. The trigger indication triggers the AVC to begin streaming real-time audio and video data over the LAN to the central security computer.

The AVC may include a memory device for storing pre-trigger audio and video data received from the camera and the microphone prior to receiving the trigger indication from the triggering device. The pre-trigger audio and video data are saved in the AVC memory when the AVC is triggered to begin streaming the real-time audio and video data to the central security computer. An alarm event timer in the central security station may terminate the streaming of real-time audio and video data from the AVC to the central security computer after a predetermined period of time has expired. This function may be overridden by a supervisor when the situation requires continued surveillance.

The AVC may include a reverse audio channel. By using a microphone connected to the central security computer and a speaker connected to the AVC, the security guard can make an audio announcement in the area of interest by transmitting the announcement from the microphone to the speaker utilizing the LAN and the reverse audio channel of the AVC.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of the system of the present invention; and

FIGS. 2A-2B are a flow chart illustrating the steps of a surveillance method performed in accordance with the teachings of the present invention.

### DETAILED DESCRIPTION OF EMBODIMENTS

The present invention is particularly useful for addressing the problem of workplace violence. The system can be quickly and inexpensively installed in the employee's office without having to run extra wire and cable. The system equipment is configured as a temporary addition to the office, not a permanent installation. When the employee's problem is resolved, the system can simply be unplugged from the employee's office and taken back to the central security station or redeployed to another potential trouble spot.

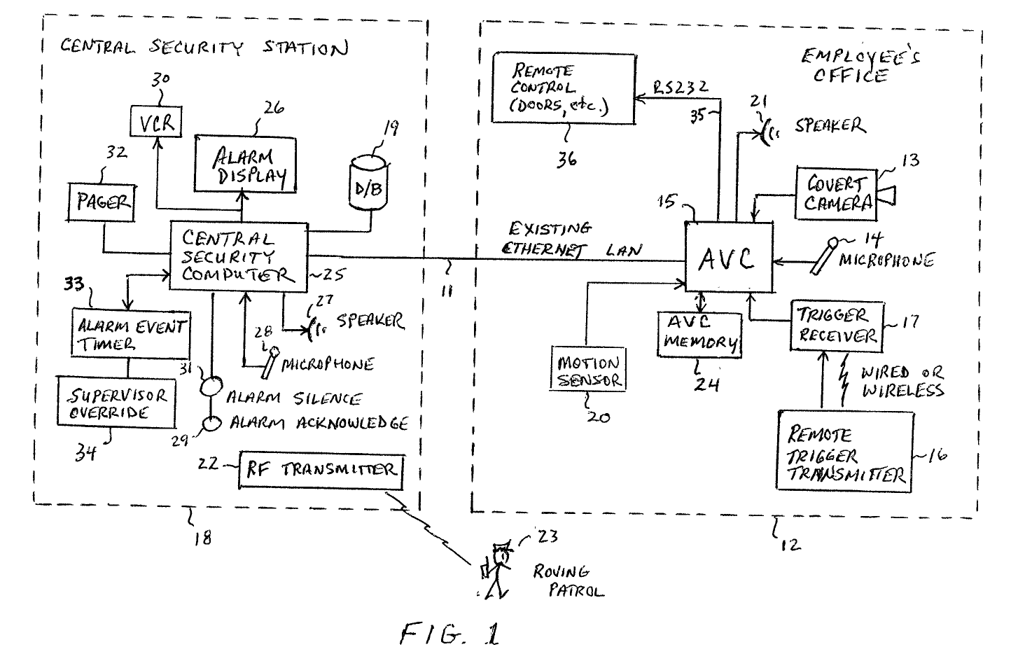

FIG. 1 is a simplified block diagram of the system of the present invention. Most large companies have an Ethernet LAN 11 already installed. The network is typically operated by an Information Technology (IT) department, rather than the Security department. The present invention is a product that can be moved into the employee's office 12, and plugged into the Ethernet jack next to the employee's computer. A covert video camera 13 is mounted in a hidden location within the office. A forward audio channel (from the employee's office to the central security station) is also provided via a hidden microphone 14. The camera and microphone plug into a MPEG audio-video compressor (AVC) 15. For example, the MG-120S MPEG video server from Hitachi America, Ltd., or an equivalent device may be utilized. The AVC may be remotely configured from the central security station. For example, the data rate can be adjusted to improve the video quality.

It should be noted that while an Ethernet LAN is utilized in the exemplary preferred embodiment described herein, any kind of data network can be used to connect the AVC 15 to the central computer 25 as long as it is fast enough and has enough bandwidth to carry the video stream.

The employee is provided with a trigger mechanism that may be wired or wireless, manual or automatic. The trigger mechanism includes a remote trigger transmitter 16 and a trigger receiver 17. For example, the employee may carry a wireless remote control in her pocket which sends signals to a receiver associated with the AVC 15. Optionally, an alternative trigger device 20 such as a directional motion sensor may be utilized to trigger the AVC. If the employee is confronted by a potential perpetrator of violence, the employee can use the remote control to trigger the AVC. The AVC then begins sending video and audio data back to a central security station 18. A monitoring security guard is then alerted that there is a potential problem in the employee's office. An alarm is sounded on the guard's console, and he is provided with video and audio information from the employee's office, and the location of the employee's office on a display screen 26. All of these events are automatically time stamped and logged in a database (D/B) 19. A Video Cassette Recorder (VCR) 30 may also be included so that the stored and time stamped video and audio data, as well as logged data showing the guard's actions (announcements, pager notifications, etc.), may be transferred at a later time to a videotape to create a comprehensive record of all events for evidence purposes.

The central security station 18 includes the D/B 19, the RF transmitter 22, a central security computer 25, an alarm display 26, a speaker 27, a microphone 28, an alarm acknowledgment button 29, an alarm silence button 31, the VCR 30, and a pager mechanism 32. The central computer may be a multimedia PC dedicated to the security function. The guard, of course, has a keyboard, mouse, or some other mechanism for interfacing with the central computer. Associated with the central computer is an alarm event timer 33 and a supervisor override function 34. The security guard can stop the alarm condition and terminate the data flow by using the alarm acknowledgment button. If the guard fails to terminate the data flow, however, the alarm event timer stops the data flow after a predetermined period of time.

The equipment may be set up by an investigator from the Security department. During the setup phase, an alarm response list is programmed to provide the monitoring security guard with a checklist of actions to be taken. The guard may receive instructions such as to make a voice announcement to the employee's office, to dispatch the roaming patrol, to call 911, to call or page the supervisor, and the like.

If it appears that there is a potential workplace violence problem, the guard can use the LAN 11 and the reverse audio channel provided by the AVC 15 to audibly communicate through a speaker 21 with the employee and the potential perpetrator. The guard may ask whether assistance is required, or simply announce that security personnel are on the way. This may have a deterrent effect on the perpetrator who may cease his threatening activities when he discovers that he is being observed, and that security personnel are on the way. These types of situations can deteriorate to violence very quickly. Therefore, an immediate audio response may be able to prevent this. The central security guard may also use an RF transmitter 22 to send a radio message to a roving patrol 23 with the location of the employee's office, and the nature of the problem. This RF transmission may be automatically initiated by the central security computer. In addition, the pager mechanism 32 may be utilized to send an audio or alphanumeric page to the roving patrol and/or the security supervisor with the location of the employee's office, and the nature of the problem. The quick arrival of the roving patrol may further help to relieve the potentially dangerous situation.

The AVC 15 includes an associated memory 24 which may be, for example, a Random Access Memory (RAM) or a Hard Disk Drive (HDD). The AVC is continually recording audio and video data in the AVC memory before the employee triggers the system to send data to the central security station 18. Under normal conditions, the data in the AVC memory is continually being overwritten by new data whenever the AVC memory space fills up. Depending on the type of memory device used, several minutes to several hours of pre-trigger video and audio data may be stored in the AVC memory. Thus, before the AVC is triggered, it does not send any video or audio data over the Ethernet LAN 11. Only when the AVC is triggered by the employee or a security supervisor with the proper access code does data begin to flow over the LAN to the central security station. Therefore, the system does not utilize network bandwidth unless an emergency situation arises requiring security assistance.

Thus, the present invention provides a solution that enables the network resource to be utilized by the Security department without using excessive bandwidth. In a large corporation, there may be several surveillance systems running on a single LAN. In some companies, the Security department may not have been given access, historically, to the Ethernet LAN because the IT department controls the LAN for more direct business purposes. The present invention provides the capability to perform surveillance in an emergency situation while essentially using none of the network bandwidth before the AVC 15 is triggered. The present invention does not use valuable network bandwidth unless an alarm condition occurs. Once triggered, the AVC may use a variable data rate to transmit video and audio data. For example, data rates up to 1.6 Mbps may be utilized, which is less than 2 percent of the network bandwidth for networks operating with 100 Mbps bandwidth.

After a trigger occurs, the pre-trigger data in the AVC memory is protected from being overwritten. At a later time when the streaming video can be stopped, the pre-trigger data can be retrieved, thus providing several minutes or hours of video and audio information regarding events leading up to the triggering event. This can be very valuable information to determine why the alarm condition occurred. In prior art covert surveillance systems, there was no data available regarding events that occurred prior to the trigger. Additionally, when using a videotape machine, it took approximately 2.5 seconds to get the videotape machine running and recording. Thus, valuable information was lost.

Before the system is triggered by the employee, the guard only receives a status indicator indicating that the system is operational. A periodic status query (ping) is sent from the central security computer 25 to the AVC 15 in the employee's office. A response from the AVC indicates that the system is operational. If the system becomes inoperative, or fails to respond to a status query, the guard is alerted.

For reasons of employee privacy, the monitoring guard does not have the ability to activate the system without a supervisor providing an access code or password to do so. It is only after the employee triggers the system that the video and audio data start to flow. Thus, the employee is ensured that the equipment is there to help them, but it is not going to invade their privacy. The security supervisor, however, is given the capability to activate the system in case a situation arises in which the employee was surprised by the perpetrator, and could not activate the system. Knowledge of this situation may reach security personnel through other employees, and the security supervisor can then turn on the system remotely from the central security station.

Also for privacy reasons, once the situation requiring the surveillance is resolved, the alarm condition is terminated, and the video and audio flow are turned off. The alarm event timer 33 turns off the video and audio flow after a predetermined period of time following the trigger. If the alarm event timer expires and the perpetrator is still in the employee's office, the supervisor can override the alarm event timer using the supervisor override function 34 and continue the audio and video surveillance. This may be required in an extreme situation such as a hostage situation in which a covert camera and microphone would be very useful for security personnel to have. The employee can also re-trigger the system. Re-triggering the system before the expiration of the alarm event timer resets the timer so that the monitoring will continue for the full allotted time.

When an alarm condition occurs, the central security computer 25 can also initiate a page, telephone call, e-mail, or other communication with a remote supervisor using, for example, the pager mechanism 32. The pager mechanism may be Ethernet, Internet, or dial out wireline or wireless modem.

The AVC 15 also has an RS-232 interface port 35. Data and instructions can be sent over the Ethernet LAN 11 from the central security station 18, and the data and instructions can be sent out the RS-232 port. Various remote control devices 36 can be controlled from the central security station in this manner. For example, the triggering of an alarm condition could remotely control devices such as security lights, door locks, window locks, pan and zoom cameras, and the like.

When the system is installed, the employee is preferably instructed to trigger the video whenever the potential perpetrator first enters the employee's office 12. This gives the guard at the central security station 18 the opportunity to view the situation on the alarm display 26 and determine whether any action should be taken. In some cases, for example where a restraining order has been issued by a court ordering the perpetrator to stay away from the employee, immediate action by the guard is warranted whenever the perpetrator violates the restraining order and comes to the employee's office. In other cases, utilizing the microphone 28, the reverse audio channel, and the speaker 21, the guard may make an announcement or ask the employee if any assistance is required.

During setup of the system, the AVC 15 is programmed with an Internet Protocol (IP) address, the IP address of the central security computer 25, and a port number. The central security computer is configured accordingly to receive data from the AVC. Additional configuration information for the central computer may include: (1) location of the employee's office; (2) the employee's telephone number; (3) textual instructions for the monitoring security guard; (4) a pager number, protocol, and message for the security supervisor and/or roving patrol; (5) an alarm display data rate, preferably between 640 Kbps and 1.6 Mbps to support audio data; and (6) date/time information to support the enabling and disabling of alarms.

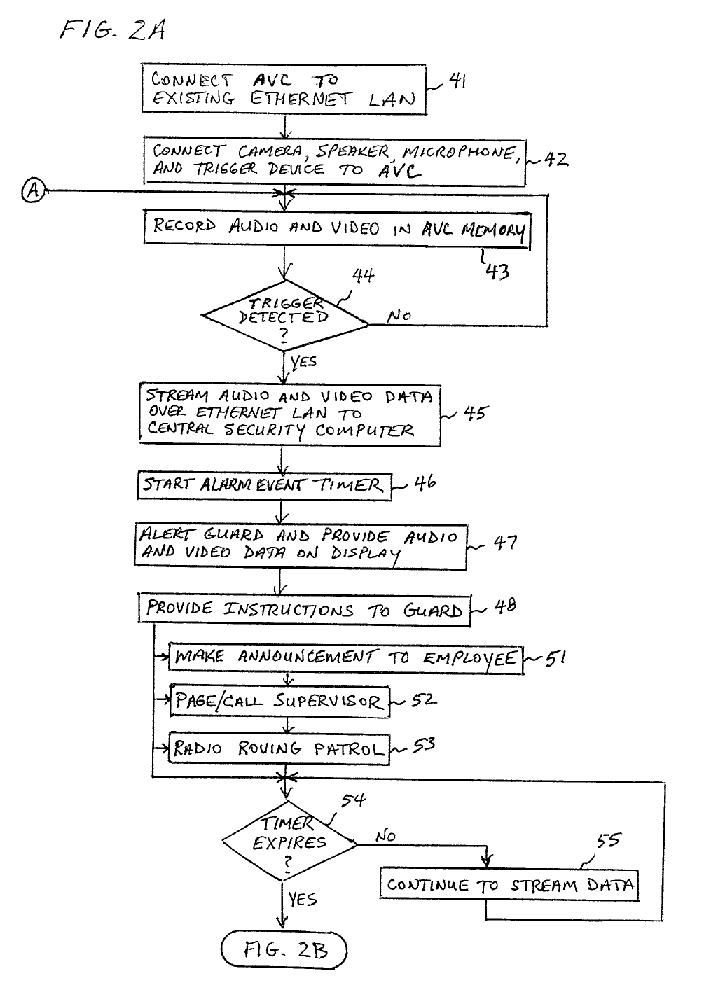

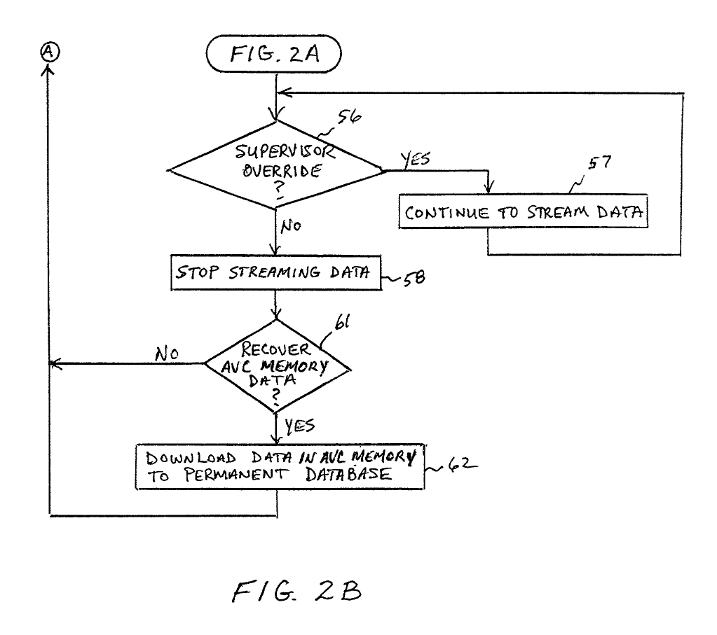

FIGS. 2A-2B are a flow chart illustrating the steps of a surveillance method performed in accordance with the teachings of the present invention. At step 41 of FIG. 2A, the AVC 15 is connected to the company's existing Ethernet LAN 11. At step 42, the covert camera 13, speaker 21, microphone 14, and wired or wireless trigger device 16, 17 are connected to the AVC. At step 43, the AVC records audio and video data into the AVC memory 24. At step 44, it is determined whether or not a trigger has been detected by the AVC. If not, the method returns to step 43 where the AVC continues to record audio and video data into the AVC memory.

However, if a trigger is detected at step 44, the method moves to step 45 where the AVC 15 begins to stream audio and video data over the Ethernet LAN 11 to the central security computer 25. At step 46, the alarm event timer 33 is started. At step 47, the monitoring security guard is alerted, and the audio and video information from the employee's office is displayed to the guard. At step 48, the central computer provides instructions to the guard. For example, the guard may be instructed to assess the situation in the employee's office, and if it appears necessary, make an announcement to the employee at step 51 using the microphone 28, the LAN 11, the speaker 21, and the reverse audio channel of the AVC. The guard may also be instructed to page or call the supervisor at step 52, or to radio the roving patrol at step 53 and dispatch the patrol to the employee's office.

After a predetermined period of time in which it is expected that a potentially violent situation would have been resolved, it is determined at step 54 whether or not the alarm event timer 33 has expired in order to protect the employee's privacy. If not, the method moves to step 55 and continues to stream audio and video data until the timer expires at 54. When the alarm event timer expires, the method moves to step 56 of FIG. 2B where it is determined whether or not the supervisor override function 34 has been initiated, indicating that a potentially dangerous situation is continuing in the employee's office. If so, the method moves to step 57 where the system continues to stream audio and video data to the central security computer. However, if the supervisor override function has not been initiated, the method moves to step 58 where the system stops streaming the audio and video data.

At step 61, it is determined whether the data stored in the AVC memory 24 is to be recovered so that pre-trigger information, for example, can be viewed by investigators. If not, the method then returns to step 43 of FIG. 2A where the system returns to the standby mode and resumes recording audio and video data into the AVC memory 24. If the data is to be recovered, however, the method moves to step 62 where the data is downloaded from the AVC memory to a permanent database such as D/B 19. The method then returns to step 43 of FIG. 2A where the system returns to the standby mode and resumes recording audio and video data into the AVC memory.

Thus, the present invention provides the company with the ability to quickly install a temporary addition to the security equipment in a designated location, and to use the existing corporate network infrastructure to transport needed video and audio information from the employee's office 12 to the central security station 18. This provides the ability to quickly respond to emergency situations that are reasonably foreseeable due to problems that a particular employee may be having.

Although the present invention may not prevent potentially violent situations from arising, it gives Security personnel the capabilities of (1) immediate response, (2) collecting data, and (3) possibly defusing the situation before violence actually erupts. All this can be done without having to install additional network infrastructure, and without adversely impacting network bandwidth on the company's Ethernet LAN before a potentially violent situation arises. From the legal perspective, the company has taken reasonable steps to ensure the safety of their employee by installing the system.

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

What is claimed is:

1. A transportable security surveillance system for rapid installation in an area of interest and rapid extraction from the area of interest, said system comprising:
a local area network (LAN) connecting a central security station to the area of interest;
a central security computer in the central security station connected to the LAN;
an audio-video compressor (AVC) in the area of interest connected to the LAN;
a video camera in the area of interest connected to the AVC, said video camera providing video data regarding the area of interest to the AVC;
a microphone in the area of interest connected to the AVC, said microphone providing audio data regarding the area of interest to the AVC; and
a triggering device in the area of interest that creates a trigger indication when a situation arises that requires real-time surveillance of the area of interest, said trigger indication triggering the AVC to begin streaming real-time audio and video data over the LAN to the central security computer.

2. The transportable security surveillance system of claim 1 wherein the AVC includes an AVC memory for storing pre-trigger audio and video data received from the camera and the microphone prior to receiving the trigger indication from the triggering device, whereby the pre-trigger audio and video data are saved in the AVC memory when the AVC is triggered to begin streaming the real-time audio and video data to the central security computer.

3. The transportable security surveillance system of claim 2 wherein the triggering device is wired to the AVC.

4. The transportable security surveillance system of claim 2 wherein the triggering device includes a wireless trigger transmitter and a trigger receiver connected to the AVC.

5. The transportable security surveillance system of claim 4 further comprising, in the central security station, an alarm display for providing a security guard with the real-time audio and video data received by the central security computer.

6. The transportable security surveillance system of claim 5 wherein the alarm display also provides instructions to the guard for handling the situation requiring surveillance in the area of interest.

7. The transportable security surveillance system of claim 6 further comprising, in the central security station, a pager mechanism connected to the central security computer that automatically pages a security supervisor when the AVC begins to stream the real-time audio and video data to the central security computer.

8. The transportable security surveillance system of claim 7 further comprising, in the central security station, an alarm event timer that terminates the streaming of real-time audio and video data from the AVC to the central security computer after a predetermined period of time has expired.

9. The transportable security surveillance system of claim 8 further comprising, in the central security station, a supervisor override function that enables the supervisor to override the alarm event timer and continue the streaming of real-time audio and video data from the AVC to the central security computer after the predetermined period of time has expired.

10. The transportable security surveillance system of claim 9 wherein the AVC includes a reverse audio channel.

11. The transportable security surveillance system of claim 10 further comprising a speaker connected to the AVC, and a second microphone, said second microphone being connected to the central security computer, whereby an audio announcement from the security guard is made in the area of interest by transmitting the announcement from the second microphone to the speaker utilizing the reverse audio channel.

12. The transportable security surveillance system of claim 11 further comprising a database for storing the real-time audio and video data after it is streamed to the central security computer.

13. The transportable security surveillance system of claim 12 wherein the AVC also includes means for downloading the pre-trigger audio and video data stored in the AVC memory, and sending the pre-trigger data to the database.

14. The transportable security surveillance system of claim 13 wherein the central security computer also time stamps the audio and video data, and time stamps and logs in the database, data regarding all actions taken by the security guard in response to the situation requiring surveillance.

15. The transportable security surveillance system of claim 14 further comprising a video cassette recorder (VCR) connected to the central security computer for transferring the time stamped audio and video data, and the time stamped data regarding the guard's actions to a videotape.

16. The transportable security surveillance system of claim 15 wherein the central security computer includes means for preventing the security guard from triggering the AVC to begin streaming real-time audio and video data over the LAN to the central security computer unless an access code is entered.

17. The transportable security surveillance system of claim 16 wherein the AVC includes an RS-232 interface, and the system further comprises at least one remote control device controlled by the AVC through the RS-232 interface.

18. The transportable security surveillance system of claim 17 wherein the central security computer includes means for sending a command over the LAN to the AVC to activate the remote control device.

19. The transportable security surveillance system of claim 18 wherein the remote control device is a remote control door lock for locking a door that provides an entrance and an exit to the area of interest.

20. A transportable security surveillance system for rapid installation in an area of interest and rapid extraction from the area of interest, said system comprising:
a local area network (LAN) connecting a central security station to the area of interest;
a central security computer in the central security station connected to the LAN;
an alarm display connected to the central security computer for providing an alarm indication and real-time video data to a security guard;
an audio-video compressor (AVC) in the area of interest connected to the LAN;
a video camera in the area of interest connected to the AVC, said video camera providing video data regarding the area of interest to the AVC; and
a triggering device in the area of interest that creates a trigger indication when a situation arises that requires real-time surveillance of the area of interest, said trigger indication triggering the AVC to begin streaming real-time video data over the LAN to the central security computer.

21. The transportable security surveillance system of claim 20 wherein the AVC includes an AVC memory for storing pre-trigger video data received from the camera prior to receiving the trigger indication from the triggering device, whereby the pre-trigger video data are saved in the AVC memory when the AVC is triggered to begin streaming the real-time video data to the central security computer.

22. The transportable security surveillance system of claim 20 wherein the AVC includes a reverse audio channel.

23. The transportable security surveillance system of claim 22 further comprising a microphone connected to the central security computer, and a speaker connected to the AVC, whereby an audio announcement from the security guard is made in the area of interest by transmitting the announcement from the microphone to the speaker utilizing the reverse audio channel.

24. The transportable security surveillance system of claim 20 further comprising a radio transmitter in the central security station for transmitting a radio message to a roving security patrol when the AVC is triggered to begin streaming the real-time video data to the central security computer.

25. The transportable security surveillance system of claim 20 further comprising, in the central security station, a pager mechanism connected to the central security computer that automatically pages a security supervisor when the AVC begins to stream the real-time video data to the central security computer.

26. The transportable security surveillance system of claim 25 wherein the pager mechanism also automatically sends a paging message to a roving security patrol when the AVC begins to stream the real-time video data to the central security computer, said paging message including an alarm indication and a location of the area of interest.
